(19) United States
(12) Patent Application Publication
(10) Pub. No.: US 2026/0301308 A1
(43) Pub. Date: Oct. 1, 2026

(54) INTERIOR IMAGE FORMATION SYSTEM AND INTERIOR IMAGE FORMATION PROGRAM

(71) Applicant: SEKISUI HOUSE, LTD., Osaka (JP)

(72) Inventors: Yukako KOMOTO, Osaka-shi (JP); Kazumi MAEHARA, Osaka-shi (JP); Naoko YANO, Osaka-shi (JP); Nao ADACHI, Osaka-shi (JP)

(21) Appl. No.: 19/489,419

(22) PCT Filed: Nov. 29, 2023
(86) PCT No.: PCT/JP2023/042682

§ 371 Date: Dec. 2, 2025

(30) Foreign Application Priority Data
Jun. 19, 2023 (JP) 2023-100201

(51) Int. Cl. G06T 15/20

(52) U.S. Cl. CPC G06T 15/20

(57) ABSTRACT

This interior image formation system forms an interior image of a target space in a building. The interior image formation system comprises a storage unit and an image formation unit. The storage unit stores: a material database including material data sets (32) of materials to enclose the target space; an object database including object data sets (34) of objects to be disposed in the target space; and structural data (30) pertaining to the structure of the target space. The image formation unit forms an interior image of the target space on the basis of the structure data (30), a material data set (32) selected from the material database, and an object data set (34) selected from the object database.

### TECHNICAL FIELD

The present disclosure relates to an interior image formation system and an interior image formation program.

### BACKGROUND ART

An interior coordinate system that coordinates an interior is known (for example, Patent Literature 1). The system disclosed in Patent Literature 1 includes a server. The server includes a user information receiver receiving an input of general information on a user, a room information receiver receiving an input of room information including configuration information on a room, and an image generator generating a 3D space image of the room based on the configuration information. The server also outputs a coordinated image in which multiple interior decor items are disposed in the 3D space image to a terminal of the user. The server narrows down the interior decor items based on information on taste preferred by the user.

### CITATION LIST

### Patent Literature

Patent Literature 1: JP2021-96545A

### SUMMARY OF INVENTION

### Technical Problem

As described above, a technique of generating an interior image is known. In the prior art, an item arranged in the subject space is selected based on preference of the user.

In architecture, determining an interior design plan takes time and effort. In addition, the interior design plan is not readily determined. An enormous number of elements for determination of the interior may hamper the user from narrowing down the preferred items. Even when the user selects a preferred item and arranges the item in a subject room, the item and the room may be out of balance. The interior as a whole may not align with the preference of the user. A designer may analyze the preference of the user based on the interior sample image and propose an interior design plan. Even in such a case, the plan may deviate from the preference of the user. Thus, the interior design planning may not proceed smoothly.

### Solution to Problem

(1) To solve the above problem, an interior image formation system forms an interior image of a subject space in a building. The interior image formation system includes storage and an image formation unit. The storage includes a member database including one or more member datasets of members surrounding the subject space, an object database including one or more object datasets of objects disposed in the subject space, and structure data related to a structure of the subject space. The image formation unit forms an interior image of the subject space based on the structure data, one of the member datasets selected from the member database, and one of the object datasets selected from the object database.

With this configuration, the interior is determined by collectively setting the members surrounding the subject space instead of selecting each element of the interior. There is no limitation on the combination of a set of members surrounding the subject space and a set of objects disposed in the subject space. This facilitates formation of an interior image that is aligned with, or is close to, requests from the user.

(2) In the interior image formation system according to (1) described above, each of the member datasets is configured, as a whole, to have a predetermined aesthetic. Each of the object datasets is configured, as a whole, to have a predetermined aesthetic. With this configuration, a member surrounding the subject space is allowed to be selected in accordance with preferred aesthetic. In addition, an object disposed in the subject space is allowed to be selected in accordance with preferred aesthetic. Thus, the interior design is smoothly determined based on the aesthetic of the user.

(3) The interior image formation system according to (2) described above further includes an information manager managing data. The information manager manages the member datasets classified into groups related to aesthetic. The information manager manages the object datasets classified into the groups related to aesthetic.

In this configuration, the member datasets are classified into groups associated with aesthetic. This facilitates narrowing down of options of the member datasets when selecting a member dataset. In the same manner, the object datasets are classified into groups associated with aesthetic. This facilitates narrowing down of options of the object datasets when selecting an object dataset.

(4) The interior image formation system according to (3) described above further includes a first selector and a second selector. Based on an input of designation of the groups related to aesthetic, the first selector selects one of the member datasets that belongs to the designated group from the member database and outputs the selected one of the member datasets to the image formation unit. Based on an input of designation of the groups related to aesthetic, the second selector selects one of the object datasets that belongs to the designated group from the object database and outputs the selected one of the object datasets to the image formation unit. The image formation unit forms the interior image based on the member dataset output from the first selector, the object dataset output from the second selector, and the structure data.

With this configuration, for the members surrounding the subject space, the member dataset for forming the interior image is determined by designating one of the groups related to the aesthetic. Also, for the objects disposed in the subject space, the object dataset for forming the interior image is determined by designating one of the groups related to the aesthetic. Thus, the interior image is readily formed.

(5) In the interior image formation system according to (4) described above, the groups related to aesthetic are associated with a peaceful aesthetic, a tender aesthetic, a spirit aesthetic, a cozy aesthetic, a luxe aesthetic, and a playful aesthetic, respectively. This configuration allows for selection of a member surrounding the subject space and an object disposed in the subject state based on any of the peaceful aesthetic, the tender aesthetic, the spirit aesthetic, the cozy aesthetic, the luxe aesthetic, and the playful aesthetic.

(6) In the interior image formation system according to (3) described above, the information manager manages the object datasets classified into groups that are related to a different index, the different index differing from the aesthetic. With this configuration, the object dataset is selected based on the different index differing from the aesthetic.

(7) The interior image formation system according to (6) described above further includes a first selector and a second selector. Based on an input of designation of the groups related to aesthetic, the first selector selects one of the member datasets that belongs to the designated group from the member database and outputs the selected one of the member datasets to the image formation unit. Based on an input of designation of the groups related to aesthetic and an input of designation of the groups related to the different index, the second selector selects one of the object datasets that belongs to the designated group from the object database and outputs the selected one of the object datasets to the image formation unit. The image formation unit forms the interior image based on the member dataset output from the first selector, the object dataset output from the second selector, and the structure data.

With this configuration, for the members surrounding the subject space, the member dataset for forming the interior image is determined by designating one of the groups related to the aesthetic. For the objects disposed in the subject space, the object dataset for forming the interior image is determined by designating one of the groups related to the aesthetic and designating one of the groups related to the different index. Thus, the interior image is readily formed.

(8) In the interior image formation system according to (7) described above, the groups related to aesthetic are respectively associated with a peaceful aesthetic, a tender aesthetic, a spirit aesthetic, a cozy aesthetic, a luxe aesthetic, and a playful aesthetic. The groups related to the different index are associated with a high price and a low price.

This configuration allows for selection of a member surrounding the subject space based on any of the peaceful aesthetic, the tender aesthetic, the spirit aesthetic, the cozy aesthetic, the luxe aesthetic, and the playful aesthetic. The configuration also allows for selection of an object disposed in the subject space based on the different index differing from the aesthetic.

(9) To solve the problem, an interior image formation program causes a computer to form an interior image of a subject space in a building based on data. The data includes a member database including one or more member datasets of members surrounding the subject space, an object database including one or more object datasets of objects disposed in the subject space, and structure data related to a structure of the subject space. The interior image formation program includes a step of forming an interior image of the subject space based on the structure data, one of the member datasets selected from the member database, and one of the object datasets selected from the object database.

With this configuration, the interior image is formed of the structure data, the member dataset surrounding the subject space, and the object dataset disposed in the subject space. There is no limitation on the combination of the member datasets surrounding the subject space and the object datasets disposed in the subject space. This facilitates formation of an interior image that is aligned with, or is close to, requests from the user.

### Advantageous Effects of Invention

According to the present disclosure, the interior image formation system and the interior image formation program facilitate formation of an interior image that is aligned with, or is close to, requests from a user.

### BRIEF DESCRIPTION OF DRAWINGS

FIG. 1 A block diagram showing an interior image formation system.

FIG. 2 A schematic diagram of a system including the interior image formation system.

FIG. 3 A schematic diagram of a member database.

FIG. 4 A schematic diagram of an object database.

FIG. 5 A diagram of table data.

FIG. 6 A diagram illustrating formation of an interior image.

FIG. 7 A diagram showing a first example of an interior image.

FIG. 8 A diagram showing a second example of an interior image.

FIG. 9 A diagram showing a third example of an interior image.

FIG. 10 A diagram showing an interior image modified by a modifier.

### DESCRIPTION OF EMBODIMENTS

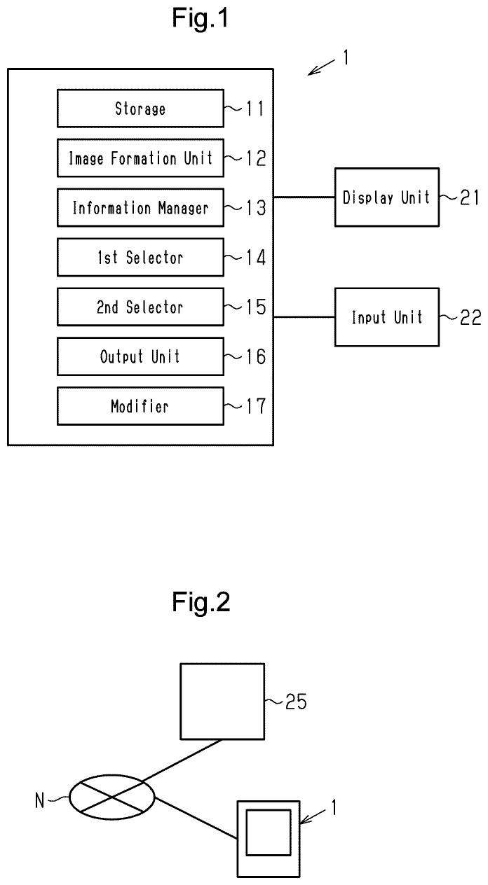

An interior image formation system 1 will now be described with reference to FIGS. 1 to 10. The term “interior” may be referred to as the “interior decor.” The interior includes at least one of a joinery fitting, a joinery material, a finishing material, an auxiliary installation, furniture, a curtain, an art piece, and an accessory. The finishing material includes a floor finishing material, a wall finishing material, and a ceiling finishing material. The auxiliary installation includes lighting, an electrical outlet, and a switch. In the present embodiment, the interior includes at least one component in a first group and at least one component in a second group, which are described below. The first group includes components that surround a subject space related to the interior. For example, the first group includes a joinery fitting, a joinery material, a finishing material, a curtain, and an electrical outlet and a switch, which are included in the auxiliary installation. The second group includes components that are disposed in the subject space related to the interior. For example, the second group includes furniture, an art piece, an accessory, and lighting, which is included in the auxiliary installation. The interior image formation system 1 includes an information terminal such as a personal computer or a smartphone. The interior image formation system 1 includes hardware of the information terminal and software installed on the information terminal. Operators of the interior image formation system 1 include a designer, a user who requests an interior design, and sales personnel. The operators of the interior image formation system 1 may include a general person. The general person includes an individual who wishes to own a home in the future or an individual who has an interest in homes.

The interior image formation system 1 forms an interior image 36P of a subject space of a building. The interior image 36P may be formed in a two-dimensional image or a three-dimensional image. An example of the interior image 36P is a perspective diagram. The interior image 36P is a type of simulation image formed based on member data related to the interior.

The space selected as the subject space is an indoor space surrounded by a wall, a ceiling, and a floor. The space selected as the subject space is a space before interior work is performed, and thus is configured to be an indoor room upon completion of the interior work. Examples of the space selected as the subject space include a space configured to be a living room, a space configured to be a dining room, a space configured to be a living-dining room, a space configured to be a dining-kitchen, and a space configured to be a living-dining-kitchen.

As shown in FIG. 1, the interior image formation system 1 includes storage 11 and an image formation unit 12. The interior image formation system 1 further includes an information manager 13. The interior image formation system 1 further includes a first selector 14 and a second selector 15. The interior image formation system 1 further includes an output unit 16. The interior image formation system 1 may further include a modifier 17.

As shown in FIG. 1, the interior image formation system 1 is configured to be connected to a display unit 21. The display unit 21 is a display for presenting information. The interior image formation system 1 outputs an interior image 36P to the display unit 21. The interior image formation system 1 is configured to be connected to an input unit 22 for inputting information. The input unit 22 includes a keyboard, a touchpad, or a touch panel. The interior image formation system 1 may include the display unit 21. The interior image formation system 1 may include the input unit 22.

The interior image formation system 1 may include an external server 25 connected via a network N. The storage 11 may be provided in the external server 25. The image formation unit 12 may also be provided in the external server 25. In this case, the interior image formation system 1 communicates with the external server 25 via the network N to acquire an interior image 36P formed in the external server 25. The interior image formation system 1 outputs the interior image 36P acquired from the external server 25 to the display unit 21 through the output unit 16.

The image formation unit 12 includes one or more central processing units (CPUs) or micro processing units (MPUs) operating based on programs. The image formation unit 12 may include a circuit including a CPU or MPU, a circuit including an application specific integrated circuit (ASIC), or a combination of these circuits. The image formation unit 12 may further include memory such as random access memory (RAM) and read only memory (ROM). The memory stores programs that cause the CPU to execute processes.

### Storage

The storage 11 includes one of semiconductor memory such as RAM and ROM, a hard disk, magnetic tape, and an optical disc. The storage 11 stores a member database 31, an object bata base, and structure data 30.

### Data

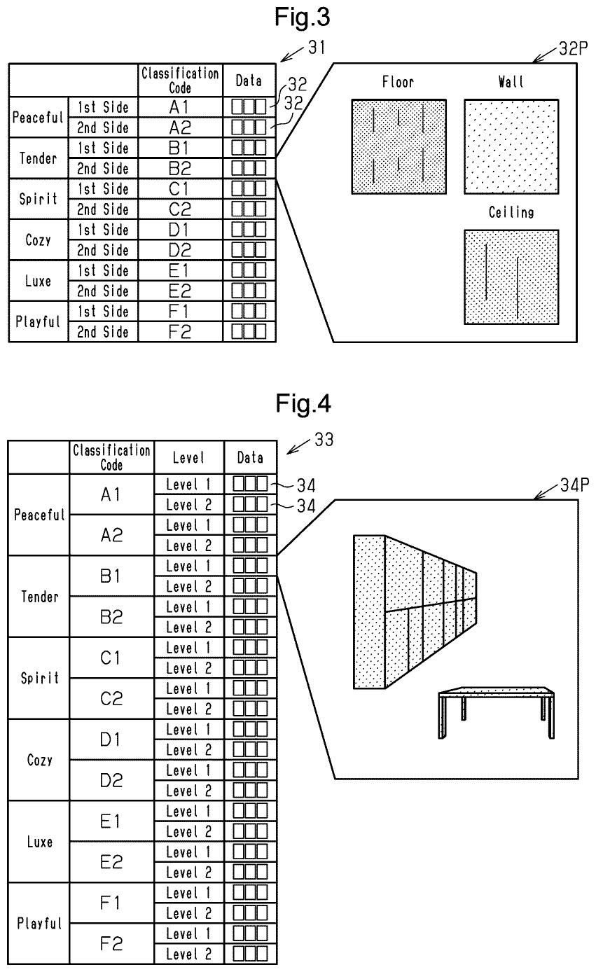

As shown in FIG. 3, the member database 31 includes member datasets 32 of members surrounding the subject space. FIG. 3 shows an example of an image 32P of a member dataset 32 visualizing the member dataset 32.

The members surrounding the subject space include a ceiling material, a wall material, a flooring material, and a curtain.

Each member dataset 32 includes member data of each member surrounding the subject space. The member data includes at least pattern data of the surface of the member. The member data may further include surface data indicating a surface state of the member. The surface state indicates irregularities, smoothness, and glossiness of the surface of the member.

The member dataset 32, as a whole, has a predetermined aesthetic. A member set is configured, as a whole, to express one aesthetic selected from a number of predetermined aesthetics. The aesthetic will be described later.

The member data in the member dataset 32 may be replaced with another member data. The replacement member data is not initially included in the member dataset 32. The replacement member data may be stored in the storage 11 or may be stored in the external server 25. For example, the external server 25 includes member data of each of different ceiling materials. In the member dataset 32, the member data of the ceiling material may be replaced with member data of a ceiling material stored in the external server 25.

As shown in FIG. 4, the object database 33 includes object datasets 34 of objects disposed in the subject space. FIG. 4 shows an example of an image 34P of an object dataset 34 visualizing the object dataset 34.

Objects disposed in the subject space include, for example, a TV stand, a sofa, a table, a shelf, and a chair. The table includes a center table and a dining table.

Each object dataset 34 includes object data of each object disposed in the subject space. The object data includes at least pattern data of the surface of the object and shape data of the object. The object data may further include surface data indicating a surface state. The surface state indicates irregularities, smoothness, and glossiness of the surface of the object.

The object dataset 34, as a whole, has a predetermined aesthetic. An object set is configured, as a whole, to express one aesthetic selected from a number of predetermined aesthetics.

The object data in the object dataset 34 may be replaced with another object data. The replacement object data is not initially included in the object dataset 34. The replacement object data may be stored in the storage 11 or may be stored in the external server 25. For example, the external server 25 includes object data of each of different shelves. In the object dataset 34, the object data of the shelf may be replaced with object data of a shelf stored in the external server 25.

The structure data 30 relates to the structure of the subject space. The subject space is constructed by building structural elements forming the structure of a building. The building structural elements include a column, a transverse beam, a longitudinal beam, a wall base material, a ceiling base material, and a flooring base material. The structure data 30 includes shape data of the building structure elements and positional relationship data indicating positional relationships of the building structure elements.

### Aesthetic

Aesthetic will now be described. Aesthetic indicates an impression or image about the interior perceived by a person. The aesthetic varies. For example, the aesthetic includes a quiet atmosphere, a peaceful atmosphere, a warm atmosphere, a cool atmosphere, an austere atmosphere, a cold atmosphere, a refreshing atmosphere, an old-fashioned atmosphere, a retro atmosphere, an American-style atmosphere, a rough atmosphere, a gorgeous atmosphere, a simple atmosphere, a rustic atmosphere, a rugged atmosphere, a wild atmosphere, a Japanese-style atmosphere, an Arabian-style atmosphere, a sacred atmosphere, a homely atmosphere, a natural atmosphere, and a lonely atmosphere.

In the present embodiment, the interior is classified into six aesthetics. Furthermore, in each aesthetic, the interior is classified into two groups.

The six aesthetics are expressed as a peaceful impression, a tender impression, a spirit impression, a cozy impression, a luxe impression, and a playful impression. The interior may be generally classified into these six aesthetics. However, the classification of the interior is not limited to the six types. The interior may be classified into four aesthetics or may be classified into eight aesthetics. The number of types of aesthetics for classifying the interior is preferably ten or less, and more preferably eight or less.

Each group of aesthetic is further classified into a first side and a second side. The first side and the second side indicate subdivided aesthetics of each of the six aesthetics. The first side and the second side are names given for convenience of classification based on the nuance.

Member sets or object sets that are classified into the same aesthetic differ from each other in nuance. To classify the member sets or object sets classified in the same aesthetic based on the nuance, each aesthetic is provided with the first side and the second side as subordinate concepts. In each aesthetic, the first side and the second side as subordinate concepts each have a different aesthetic.

The impression of each aesthetic will now be described.

The peaceful impression is an aesthetic impression of an interior decor that conveys a serene atmosphere. A unifying low-contrast tone within the same color family, together with rounded silhouettes of furniture and accessories, characterizes the peaceful.

The tender impression is an aesthetic impression of an interior decor that conveys a refreshing atmosphere. A combination of natural wood and white, providing a neat impression, with furniture having gentle curves that highlight the natural features of the wood, characterizes the tender.

The spirit impression is an aesthetic impression of an interior decor that conveys an intense atmosphere. Furniture having subdued natural materials, expressing spatial margin, or furniture having crisp lines characterizes the spirit.

The cozy impression is an aesthetic impression of an interior decor that conveys a warm atmosphere. Colors highlighting the quality of the material, together with sturdy furniture, characterize the cozy.

The luxe impression is an aesthetic impression of an interior decor that conveys a luxurious atmosphere. A combination of dark tones and glossy materials or luxurious furniture characterizes the luxe.

The playful impression is an aesthetic impression of an interior decor that conveys an uplifting atmosphere. The background of a simple refined space, evoking the imagination of incorporating colors through furniture and accessories or highlighting the silhouettes, characterizes the playful.

### Information Manager

### (a) Classification Management Based on Aesthetic

The information manager 13 manages data.

The information manager 13 manages the member datasets 32 that are classified into groups related to aesthetic. The groups related to aesthetic are associated with the peaceful aesthetic, the tender aesthetic, the spirit aesthetic, the cozy aesthetic, the luxe aesthetic, and the playful aesthetic, respectively. That is, the information manager 13 manages the member datasets 32, each of which is in a state belonging to one of the peaceful group, the tender group, the spirit group, the cozy group, the luxe group, and the playful group.

The information manager 13 further manages the member datasets 32 that are classified into groups based on differences in nuance in the aesthetic. The groups classified based on the nuance differences are classified into one of the first side and the second side.

In the present embodiment, twelve groups are formed based on the six aesthetics and the nuance differences and each are associated with a classification code. The information manager 13 manages the member datasets 32 by assigning a classification code to each member dataset 32.

A member set related to the member dataset 32 belongs to one of the peaceful group, the tender group, the spirit group, the cozy group, the luxe group, and the playful group.

The information manager 13 manages the object datasets 34 that are classified into groups related to aesthetic. The groups related to aesthetic are each associated with one of the peaceful aesthetic, the tender aesthetic, the spirit aesthetic, the cozy aesthetic, the luxe aesthetic, and the playful aesthetic. That is, the information manager 13 manages the object datasets 34, each of which is in a state belonging to one of the peaceful group, the tender group, the spirit group, the cozy group, the luxe group, and the playful group. Each object dataset 34 belongs to one of the peaceful group, the tender group, the spirit group, the cozy group, the luxe group, and the playful group.

The information manager 13 further manages the object datasets 34 that are classified into groups based on differences in nuance in the aesthetic. The groups classified based on the nuance differences are classified into one of the first side and the second side. The information manager 13 manages the object datasets 34 by assigning a classification code to each object dataset 34 in the same manner as for the member datasets 32.

### (b) Classification Management by Different Index

The information manager 13 manages the object datasets 34 that are classified into groups associated with a different index that differs from the aesthetic. The groups associated with the different index include Level 1 and Level 2. Each object dataset 34 belongs to one of Level 1 and Level 2.

The different index indicates a perspective that differs from impression or image perceived by a person about an object. The different index is not limited. Examples of the different index include the price of an object, the quality of the object, and the place where the object is produced. In the present embodiment, the different index is the price of the object. In the present embodiment, Level 1 indicates a high price. Level 2 indicates a low price.

### Prepared Data

Member datasets 32 that conform to each of the six aesthetics are prepared in advance. Two member datasets 32 are prepared in advance for each aesthetic. In each aesthetic, one of the two member datasets 32 conforms to the first side, and the other member dataset 32 conforms to the second side. Therefore, twelve member datasets 32 differing in aesthetic and subordinate concepts of the aesthetic are stored in the storage 11.

Object datasets 34 that conform to each of the six aesthetics are prepared in advance. Four object datasets 34 are prepared in advance for each aesthetic. In each aesthetic, two of the four object datasets 34 conform to the first side, and the other two of the four object datasets 34 conform to the second side. In each aesthetic, one of the two object datasets 34 conforming to the first side conforms to Level 1, and the other object dataset 34 conforms to Level 2. In each aesthetic, one of the two object datasets 34 conforming to the second side conforms to Level 1, and the other object dataset 34 conforms to Level 2. Therefore, the storage 11 stores twenty-four object datasets 34 differing in aesthetic, subordinate concepts of the aesthetic, and levels.

An image 32P related to a member dataset 32 is shown on the display unit 21 through the output unit 16. The image 32P of the member dataset 32 is shown on the display unit 21 together with information of the group to which the member dataset 32 belongs. For example, an image 32P of a member dataset 32 classified into the “peaceful” and the “first side” is shown on the display unit 21 together with a name corresponding to “peaceful” and “first side.” This allows the operator to know the group that the shown member dataset 32 belongs to. The operator of the interior image formation system 1 may perform a predetermined operation with the input unit 22 to sequentially show the member datasets 32 on the display unit 21. This allows the operator to check the member datasets 32 through the display unit 21.

An image 34P related to an object dataset 34 is shown on the display unit 21 through the output unit 16. The image 34P of the object dataset 34 is shown on the display unit 21 together with the name of the group to which the object dataset 34 belongs and information of the different index. For example, an image 34P of an object dataset 34 classified into the “peaceful,” the “first side,” and “Level 1” is shown on the display unit 21 together with a name corresponding to “peaceful,” “first side,” and “Level 1.” This allows the operator to know the group that the shown object dataset 34 belongs to and the level of the object dataset 34. The operator of the interior image formation system 1 may perform a predetermined operation with the input unit 22 to sequentially show the object datasets 34 on the display unit 21. This allows the operator to check the object datasets 34 through the display unit 21.

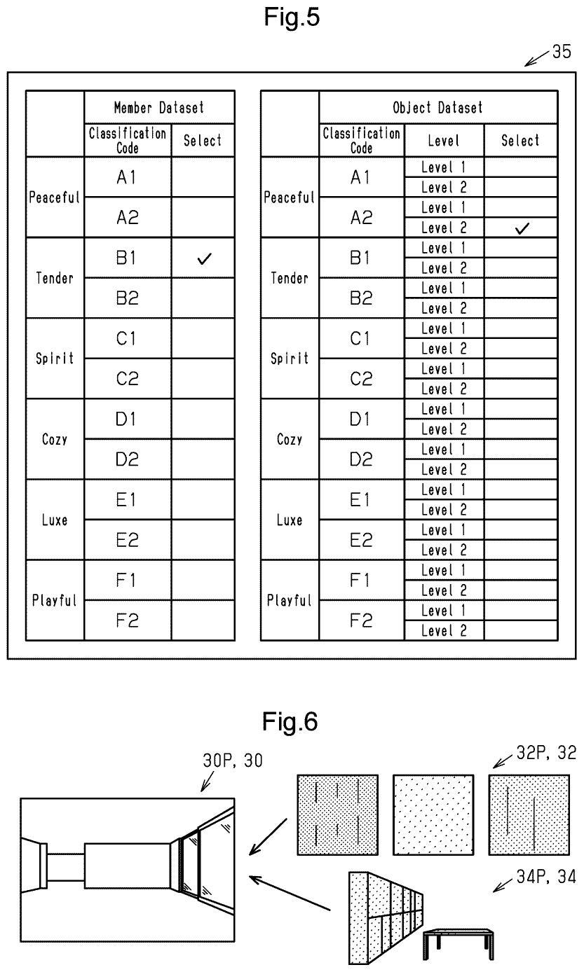

Selection of a group related to the member datasets 32 and selection of a group related to the object datasets 34 will be described with reference to FIG. 5.

### First Selector

The first selector 14 is arranged to select a member dataset 32 from the member database 31. The first selector 14 receives designation of the groups related to aesthetic from the input unit 22. The designation of the groups related to aesthetic is performed in different processes.

In a first example, when a designer knows preference of a user about the members surrounding the subject space, the designer designates a group related to aesthetic. The designer interviews the user to obtain the preference of the user. While showing images 32P of the member datasets 32 related to each group to the user, the designer obtains the preference of the user. From the interview, the designer determines the aesthetic preferred by the user. For example, when the aesthetic preferred by the user is the first side in the peaceful, the designer designates the group of the “peaceful” and the “first side.” The designation related to the groups related to aesthetic is stored as table data 35 (refer to FIG. 5).

In a second example, the user designates members surrounding the subject space. The user sequentially checks the images 32P related to the member datasets 32 shown on the display unit 21. Each member dataset 32 shown on the display unit 21 belongs to one of the groups related to aesthetic. The user selects one of the images 32P of the member datasets 32. Thus, the user indirectly designates one of the groups related to aesthetic. The information manager 13 designates the group related to the aesthetic based on the image 32P of the member dataset 32 selected by the user. For example, when the user selects an image 32P of the member dataset 32 belonging to the group of the “peaceful” and the “first side,” the information manager 13 designates the group of the “peaceful” and the “first side” based on the selection. The designation related to the aesthetic is stored as the table data 35 (refer to FIG. 5). As a result of the storing, the preference of the user is saved as data. When the designation of the group is stored in the storage 11, the member dataset 32 selected by the user may also be stored in the storage 11.

Based on an input of designation of the groups related to aesthetic, the first selector 14 selects a member dataset 32 belonging to the designated group from the member database 31 (refer to FIG. 5). The first selector 14 then outputs the selected member dataset 32 to the image formation unit 12.

### Second Selector

The second selector 15 is arranged to select an object dataset 34 from the object database 33. The second selector 15 receives designation of the groups related to aesthetic from the input unit 22. The designation of the groups related to aesthetic is performed in different processes.

In a first example, when a designer knows the preference of a user about the objects disposed in the subject space, the designer designates the group related to aesthetic. The designer interviews the user to obtain the preference of the user. While showing images 34P of the object datasets 34 related to each group to the user, the designer obtains the preference of the user. From the interview, the designer determines aesthetic that is preferred by the user. For example, when the aesthetic preferred by the user is the second side in the tender, the designer designates the group of the “tender” and the “second side.” The designation related to the groups related to aesthetic is stored as the table data 35 (refer to FIG. 5).

In a second example, the user designates objects disposed in the subject space. The user sequentially checks the images 34P related to the object datasets 34 shown on the display unit 21. Each object dataset 34 shown on the display unit 21 belongs to one of the groups related to aesthetic. The user selects one of the images 34P of the object datasets 34. Thus, the user indirectly designates one of the groups related to aesthetic. The information manager 13 designates the group related to the aesthetic based on the image 34P of the object dataset 34 selected by the user. For example, when the user selects an image 34P of the object dataset 34 belonging to the group of the “tender” and the “second side,” the information manager 13 designates the group of the “tender” and the “second side” based on the selection. The designation related to the aesthetic is stored as the table data 35 (refer to FIG. 5). As a result of the storing, the preference of the user is saved as data. When the designation of the group is stored in the storage 11, the object dataset 34 selected by the user may also be stored in the storage 11.

The second selector 15 receives designation of the groups related to the different index from the input unit 22. The groups related to the different index are designated by a user or a designer. When the different index is a price range, the designation is performed by the user or a designer who knows the preference of the user. An index related to the different index is designated using the input unit 22.

The second selector 15 receives designation (hereinafter referred to as the “first designation”) of the groups related to aesthetic. Further, the second selector 15 receives designation (hereinafter referred to as the “second designation”) of the groups related to the different index.

Based on the first designation and the second designation, the second selector 15 selects an object dataset 34 belonging to the group related to the designation from the object database 33 (refer to FIG. 5). The second selector 15 then outputs the selected object dataset 34 to the image formation unit 12.

### Image Formation Unit

The image formation unit 12 will be described with reference to FIG. 6. FIG. 6 is a diagram illustrating formation of an interior image 36P. FIG. 6 shows an image 30P visualizing the structure data 30, an image 32P visualizing a member dataset 32, and an image 34P visualizing an object dataset 34.

The image formation unit 12 forms the interior image 36P of the subject space based on the structure data 30, the member dataset 32, and the object dataset 34. Specifically, the interior image 36P is formed by arranging the member dataset 32 and the object dataset 34 in the space indicated by the structure data 30. The member dataset 32 is output from the first selector 14. The object dataset 34 is output from the second selector 15. The interior image 36P is shown on the display unit 21 through the output unit 16.

### Modifier

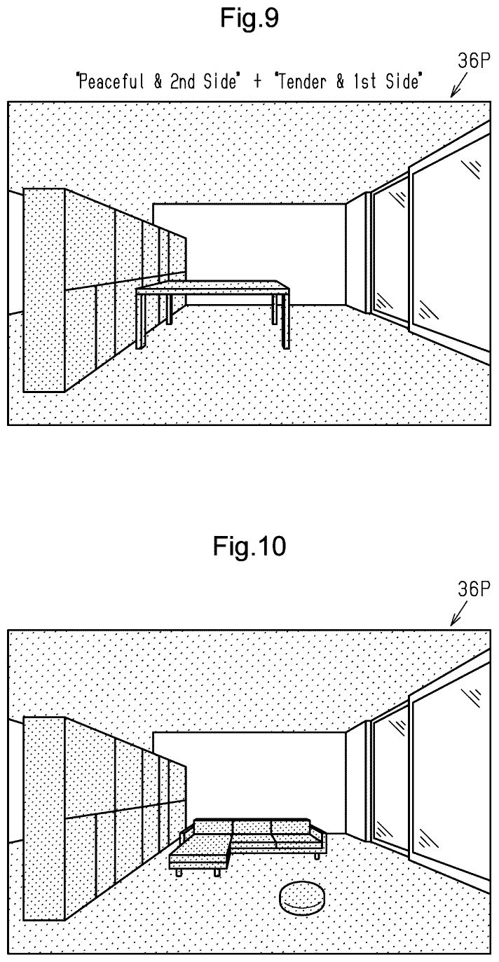

Modification of the interior image 36P will be described with reference to FIGS. 9 and 10. The interior image 36P shown in FIG. 10 is obtained by changing the interior image 36P shown in FIG. 9 such that the member data related to a table is changed to the member data related to a sofa.

The modifier 17 changes the member data selected from the member datasets 32 in the interior image 36P formed by the image formation unit 12. Specifically, the modifier 17 changes member data in the interior image 36P by selecting member data that is to be removed from the interior image 36P and selecting member data from the data stored in the external server 25.

The modifier 17 also changes the object data selected from the object datasets 34 in the interior image 36P formed by the image formation unit 12. Specifically, the modifier 17 changes object data in the interior image 36P by selecting object data that is to be removed from the interior image 36P and selecting object data from the data stored in the external server 25. The modifier 17 modifies the interior image 36P in accordance with requests from the user.

### Operation of the Present Embodiment

The interior is designed based on the preference of a user. In a first example, from catalogs, a person selects a member forming the wall, a member forming the ceiling, and a member forming the floor for a subject space and also selects a shelf, a table, and a chair disposed in the subject space. In this example, after all of the elements forming the interior of the subject space are determined, the design needs to be further adjusted by changing the members in order to achieve the harmony of the interior as a whole. In a second example, a designer obtains the preference of the user and then creates a perspective diagram corresponding to the preference of the user. In order to obtain the preference of the user, the designer prepares in advance several perspective diagrams of the interior in accordance with the aesthetics. The perspective diagrams of the interior in accordance with the aesthetics (hereinafter referred to as reference perspective diagrams) may include all of a wall, a ceiling, a floor, a shelf, a table, and a chair in the subject space that are harmonized as a whole. The user views the reference perspective diagrams to designate one that the user prefers.

However, the reference perspective diagram designated by the user may be deviated far from actual preference of the user. One factor is the limited number of reference perspective diagrams relative to the wide variety of user preferences. Although the types of reference perspective diagrams may be increased, when the entirety of the interior of each diagram is viewed as a single object, it is difficult to classify the diagram into a number of groups based on the aesthetic.

In the present embodiment, the entirety of the interior is not viewed as a single object. Instead, the entirety of the interior is divided into members surrounding the subject space and objects disposed in the subject space. The member sets surrounding the subject space and the object sets disposed in the subject space are each classified based on aesthetic. The aesthetic preferred by the user about the members surrounding the subject space and the aesthetic preferred by the user about the objects disposed in the subject space are separately obtained. Then, the interior image 36P is formed based on the member dataset 32 of the members surrounding the subject space, the object dataset 34 of the objects disposed in the subject space, and the structure data 30. This limits deviation of the interior image 36P from the preference of the user.

The combination of the member dataset 32 of the members surrounding the subject space and the object dataset 34 of the objects disposed in the subject space may express a new aesthetic that is less likely to be expressed when the entirety of the interior is viewed as a single object. The new aesthetic conventionally exists but is less likely to be expressed. Such a new aesthetic is not readily conceived by a designer but may conform to preference of the user. Accordingly, the system of the present embodiment allows obtainment of preference of a user that is not readily obtained.

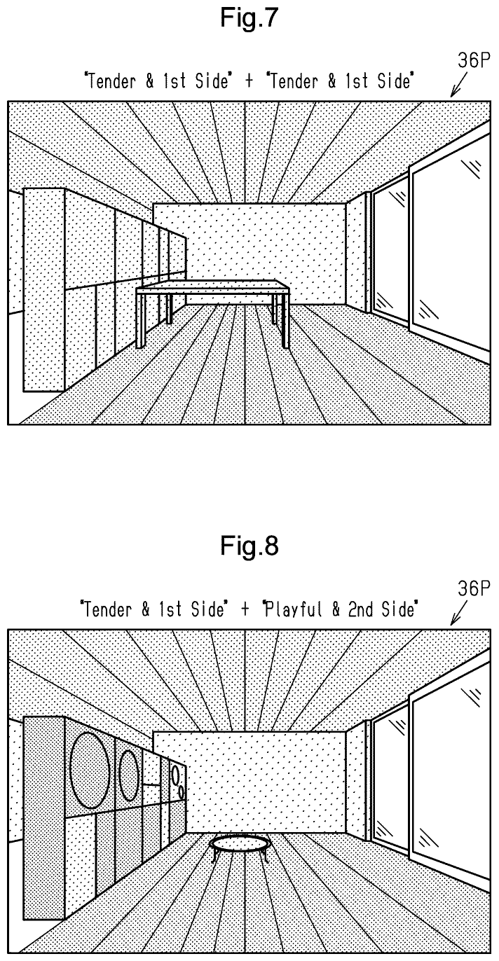

Examples of combinations of the member dataset 32 and the object dataset 34 will be described with reference to FIGS. 7 to 9. New aesthetics that are less likely to be expressed by a typical process will be described based on examples of combinations.

FIG. 7 is a diagram showing a first example of the interior image 36P. The interior image 36P of the first example is formed by a combination of the member dataset 32 of the “tender” and the “first side” and the object dataset 34 of the “tender” and the “first side.” In this example, the member dataset 32 and the object dataset 34 are unified by the same aesthetic.

FIG. 8 is a diagram showing a second example of the interior image 36P. The interior image 36P of the second example is formed by a combination of the member dataset 32 of the “tender” and the “first side” and the object dataset 34 of the “playful” and the “second side.” The interior image 36P of the second example is obtained by changing the object dataset 34 to an object dataset 34 of a different aesthetic in the interior image 36P of the first example. Typically, members surrounding the subject space and objects disposed in the subject space are often unified by the same aesthetic. However, in this example, the aesthetic of the objects disposed in the subject space differs from the aesthetic of the members surrounding the subject space. This interior image 36P expresses an aesthetic that is less likely to be expressed by a typical process.

FIG. 9 is a diagram showing a third example of the interior image 36P. The interior image 36P of the third example is formed by a combination of the member dataset 32 of the “peaceful” and the “second side” and the object dataset 34 of the “tender” and the “first side.” The interior image 36P of the third example is obtained by changing the member dataset to a member dataset 32 of a different aesthetic in the interior image 36P of the first example. Typically, members surrounding the subject space and objects disposed in the subject space are often unified by the same aesthetic. However, in this example, the aesthetic of the objects disposed in the subject space differs from the aesthetic of the members surrounding the subject space. This interior image 36P expresses an aesthetic that is less likely to be expressed by a typical process.

As described above, the interior image formation system 1 readily forms various interior images 36P differing from each other in aesthetic. This facilitates formation of an interior image 36P that is aligned with, or is close to, requests from a user.

### Effect of the Present Embodiment

(1) In the interior image formation system 1, the image formation unit 12 forms the interior image 36P of the subject space based on the structure data 30, the member dataset 32 selected from the member database 31, and the object dataset 34 selected from the object database 33.

With this configuration, the interior is determined by collectively setting the members surrounding the subject space instead of selecting each element of the interior. The objects disposed in the subject space are also collectively set. In addition, there is no limitation on the combination of a set of members surrounding the subject space and a set of objects disposed in the subject space. This allows for an abundant variations of interior as a whole.

A typical interior design is determined on the assumption that the preference of a user about a member surrounding the subject space is the same as preference of the user about an object disposed in the subject space. Hence, the interior has the same tone as a whole. However, preference and lifestyle vary between users, and a user may not necessarily seek a beautiful harmony or uniformity of the interior as a whole. When an interior image 36P is formed by a typical interior determination process, it is difficult for the interior image 36P to be aligned with requests from the user. In addition, it takes a relatively long time to reach an interior image 36P aligned with requests from the user.

In this regard, in the above configuration, there is no limitation on the combination of a set of members surrounding the subject space and a set of objects disposed in the subject space. This facilitates formation of an interior image 36P that is aligned with, or is close to, requests from the user.

(2) The member dataset 32, as a whole, has a predetermined aesthetic. The object dataset 34, as a whole, has a predetermined aesthetic. With this configuration, a member surrounding the subject space is allowed to be selected in accordance with preferred aesthetic. In addition, an object disposed in the subject space is allowed to be selected in accordance with a preferred aesthetic. Thus, the interior design is smoothly determined based on the aesthetic of the user.

(3) In the interior image formation system 1, the information manager 13 manages the member datasets 32 that are classified into groups related to aesthetic. The information manager 13 manages the object datasets 34 that are classified into groups related to aesthetic.

In this configuration, the member datasets 32 are classified into groups associated with aesthetic. Thus, when selecting a member dataset 32, the options are readily narrowed down. Also, the object datasets 34 are classified into groups associated with aesthetic. Thus, when selecting an object dataset 34, the options are readily narrowed down.

(5) In the interior image formation system 1, the groups related to aesthetic are associated with the peaceful aesthetic, the tender aesthetic, the spirit aesthetic, the cozy aesthetic, the luxe aesthetic, and the playful aesthetic, respectively. This configuration allows for selection of a member surrounding the subject space and an object disposed in the subject state based on any of the peaceful aesthetic, the tender aesthetic, the spirit aesthetic, the cozy aesthetic, the luxe aesthetic, and the playful aesthetic.

(6) In the interior image formation system 1, the information manager 13 manages the object datasets 34 that are classified into groups related to a different index that differs from the aesthetic. With this configuration, the object dataset 34 is selected based on the different index, which differs from the aesthetic.

(7) The interior image formation system 1 further includes the first selector 14 and the second selector 15. Based on an input of designation related to the aesthetic, the first selector 14 selects the member dataset 32 belonging to the designated group from the member database 31. Based on an input of designation related to the aesthetic and an input of designation related to the different index, the second selector 15 selects the object dataset 34 belonging to the designated groups from the object database 33. The image formation unit 12 forms the interior image 36P based on the member dataset 32 output from the first selector 14, the object dataset 34 output from the second selector 15, and the structure data 30.

With this configuration, for members surrounding the subject space, one of the groups related to the aesthetic is designated to determine the member dataset 32 that forms the interior image 36P. For objects disposed in the subject space, one of the groups related to the aesthetic is designated, and one of the groups related to the different index is designated to determine the object dataset 34 that forms the interior image 36P. Thus, the interior image 36P is readily formed. Additionally, information on the different index is used in addition to the information on the aesthetic. This facilitates formation of an interior image 36P that aligns with requests from a user.

(8) In the interior image formation system 1, the groups related to aesthetic are associated with the peaceful aesthetic, the tender aesthetic, the spirit aesthetic, the cozy aesthetic, the luxe aesthetic, and the playful aesthetic, respectively. The groups related to the different index are associated with a high price and a low price.

This configuration allows for selection of a member surrounding the subject space based on any of the peaceful aesthetic, the tender aesthetic, the spirit aesthetic, the cozy aesthetic, the luxe aesthetic, and the playful aesthetic. The configuration also allows for selection of an object disposed in the subject space based on the different index differing from the aesthetic.

### Modified Examples

The above embodiment exemplifies, without any intention to limit, applicable forms of the interior image formation system 1. The system is applicable to forms different from the examples described in the above embodiment. For example, the structures of the embodiment may be replaced, changed, or omitted in part or include additional elements. Modified examples of the embodiment will be described below.

### Modified Example of the Second Selector

In the embodiment, the second selector 15 receives designation of the groups related to aesthetic and designation of the groups related to the different index. Alternatively, the receiving of designation of the groups related to the different index may be omitted from the configuration of the second selector 15.

In this case, based on receiving of designation of the groups related to aesthetic, the second selector 15 selects an object dataset 34 belonging to the designated group from the object database 33. The second selector 15 then outputs the selected object dataset 34 to the image formation unit 12. The image formation unit 12 forms the interior image 36P based on the member dataset 32 output from the first selector 14, the object dataset 34 output from the second selector 15, and the structure data 30.

With this configuration, for members surrounding the subject space, one of the groups related to the aesthetic is designated to determine the member dataset 32 that forms the interior image 36P. Also, for objects disposed in the subject space, one of the groups related to the aesthetic is designated to determine the object dataset 34 that forms the interior image 36P. Thus, the interior image 36P is readily formed.

### Program

The interior image formation system 1 may include a program.

The interior image formation program causes a computer to form an interior image 36P of a subject space of a building based on data. The data includes the member database 31 including the member datasets 32 of members surrounding the subject space, the object database 33 including the object datasets 34 of objects disposed in the subject space, and the structure data 30 related to the structure of the subject space. The interior image formation program executes the following step. In the step, the interior image formation program causes the computer to form an interior image 36P of the subject space based on the structure data 30, the member dataset 32 selected from the member database 31, and the object dataset 34 selected from the object database 33.

With this configuration, the interior image 36P is formed of the structure data 30, the member dataset 32 surrounding the subject space, and the object dataset 34 disposed in the subject space. There is no limitation on the combination of the member datasets 32 surrounding the subject space and the object datasets 34 disposed in the subject space. This facilitates formation of an interior image 36P that is aligned with, or is close to, requests from the user.

The following describes the technical aspects disclosed in the specification.

### Clause 1

A technique according to clause 1 is an interior image formation system forming an interior image of a subject space of a building. The interior image formation system includes storage and an image formation unit. The storage stores a member database including one or more member datasets of members surrounding the subject space, an object database including one or more object datasets of objects disposed in the subject space, and structure data related to a structure of the subject space. The image formation unit forms an interior image of the subject space based on the structure data, one of the member datasets selected from the member database, and one of the object datasets selected from the object database.

### Clause 2

In the interior image formation system according to clause 1, each member dataset is configured, as a whole, to have a predetermined aesthetic. Each object dataset is configured, as a whole, to have a predetermined aesthetic.

### Clause 3

The interior image formation system according to clause 1 further includes an information manager managing data. The information manager manages the member datasets classified into groups related to aesthetic. The information manager manages the object datasets classified into the groups related to aesthetic.

### Clause 4

The interior image formation system according to clause 3 further includes a first selector and a second selector. Based on an input of designation of the groups related to aesthetic, the first selector selects one of the member datasets that belongs to the designated group from the member database and outputs the selected one of the member datasets to the image formation unit. Based on an input of designation of the groups related to aesthetic, the second selector selects one of the object datasets that belongs to the designated group from the object database and outputs the selected one of the object datasets to the image formation unit. The image formation unit forms the interior image based on the member dataset output from the first selector, the object dataset output from the second selector, and the structure data.

### Clause 5

In the interior image formation system according to clause 4, the groups related to aesthetic are associated with a peaceful aesthetic, a tender aesthetic, a spirit aesthetic, a cozy aesthetic, a luxe aesthetic, and a playful aesthetic, respectively.

### Clause 6

In the interior image formation system according to clause 3, the information manager manages the object datasets classified into groups that are related to a different index, the different index differing from the aesthetic.

### Clause 7

The interior image formation system according to clause 6 further includes a first selector and a second selector. Based on an input of designation of the groups related to aesthetic, the first selector selects one of the member datasets that belongs to the designated group from the member database and outputs the selected one of the member datasets to the image formation unit. Based on an input of designation of the groups related to aesthetic and an input of designation of the groups related to the different index, the second selector selects one of the object datasets that belongs to the designated group from the object database and outputs the selected one of the object datasets to the image formation unit. The image formation unit forms the interior image based on the member dataset output from the first selector, the object dataset output from the second selector, and the structure data.

### Clause 8

In the interior image formation system according to clause 7, the groups related to aesthetic are associated with a peaceful aesthetic, a tender aesthetic, a spirit aesthetic, a cozy aesthetic, a luxe aesthetic, and a playful aesthetic, respectively. The groups related to the different index are associated with a high price and a low price.

### Clause 9

A technique according to clause 9 is an interior image formation program causing a computer to form an interior image of a subject space of a building based on data. In the interior image formation program, the data including a member database including one or more member datasets of members surrounding the subject space, an object database including one or more object datasets of objects disposed in the subject space, and structure data related to a structure of the subject space. The interior image formation program executes the following step. In the step, the interior image formation program causes the computer to form an interior image of the subject space based on the structure data, one of the member datasets selected from the member database, and one of the object datasets selected from the object database.

### REFERENCE SIGNS LIST

1) interior image formation system, 11) storage, 12) image formation unit, 13) information manager, 14) first selector, 15) second selector, 30) structure data, 31) member database, 32) member dataset, 33) object database, 34) object dataset, 36P) interior image.

1. An interior image formation system forming an interior image of a subject space in a building, the interior image formation system, comprising:
storage;
an image formation unit;
an information manager managing data;
a first selector; and
a second selector, wherein
the storage includes
a member database including one or more member datasets of members surrounding the subject space,
an object database including one or more object datasets of objects disposed in the subject space, and
structure data related to a structure of the subject space,
the information manager manages the member datasets classified into groups related to aesthetic, and manages the object datasets classified into the groups related to aesthetic,
with respect to the aesthetic preferred by the user about the members surrounding the subject space that is separate from the aesthetic preferred by the user about the objects disposed in the subject space, based on an input of designation of the groups related to aesthetic, the first selector selects one of the member datasets that belongs to the designated group from the member database and outputs the selected one of the member datasets to the image formation unit,
with respect to the aesthetic preferred by the user about the objects disposed in the subject space that is separate from the aesthetic preferred by the user about the members surrounding the subject space, based on an input of designation of the groups related to aesthetic, the second selector selects one of the object datasets that belongs to the designated group from the object database and outputs the selected one of the object datasets to the image formation unit,
the image formation unit forms the interior image of the subject space based on the member dataset output from the first selector, the object dataset output from the second selector, and the structure data,
the groups related to aesthetic are associated with a peaceful aesthetic, a tender aesthetic, a spirit aesthetic, a cozy aesthetic, a luxe aesthetic, and a playful aesthetic, respectively.
each of the member datasets includes member data of each member surrounding the subject space, and is configured, as a whole, to have a predetermined aesthetic, the predetermined aesthetic is one of the groups related to aesthetic,
each of the object datasets includes object data of each object disposed in the subject space, and is configured, as a whole, to have a predetermined aesthetic, and the predetermined aesthetic is one of the groups related to aesthetic.

2. (canceled)

3. (canceled)

4. (canceled)

5. (canceled)

6. The interior image formation system according to claim 1, wherein in addition to managing the object datasets classified into the groups related to aesthetic, the information manager further manages the object datasets classified into groups that are related to a different index, the different index differing from the aesthetic.

7. The interior image formation system according to claim 6,
wherein
based on an input of designation of the groups related to aesthetic and an input of designation of the groups related to the different index, the second selector selects one of the object datasets that belongs to the designated group from the object database and outputs the selected one of the object datasets to the image formation unit.

8. The interior image formation system according to claim 7, wherein
the groups related to the different index are associated with a high price and a low price.

9. An interior image formation program causing a computer to form an interior image of a subject space in a building based on data, the data including a member database including one or more member datasets of members surrounding the subject space, an object database including one or more object datasets of objects disposed in the subject space, and structure data related to a structure of the subject space, the interior image formation program causing the computer to manage the member datasets classified into groups related to aesthetic and manage the object datasets classified into the groups related to aesthetic, and the interior image formation program causing the computer to perform:
a first step of selecting, with respect to the aesthetic preferred by the user about the members surrounding the subject space that is separate from the aesthetic preferred by the user about the objects disposed in the subject space, based on an input of designation of the groups related to aesthetic, one of the member datasets that belongs to the designated group from the member database,
a second step of selecting, with respect to the aesthetic preferred by the user about the objects disposed in the subject space that is separate from the aesthetic preferred by the user about the members surrounding the subject space, based on an input of designation of the groups related to aesthetic, one of the object datasets that belongs to the designated group from the object database, and
a third step of forming the interior image of the subject space based on the member dataset selected in the first step, the object dataset selected in the second step, and the structure data, wherein
the groups related to aesthetic are associated with a peaceful aesthetic, a tender aesthetic, a spirit aesthetic, a cozy aesthetic, a luxe aesthetic, and a playful aesthetic, respectively.
each of the member datasets includes member data of each member surrounding the subject space, and is configured, as a whole, to have a predetermined aesthetic, the predetermined aesthetic is one of the groups related to aesthetic,
each of the object datasets includes object data of each object disposed in the subject space, and is configured, as a whole, to have a predetermined aesthetic, and the predetermined aesthetic is one of the groups related to aesthetic.
